(19) United States
(12) Patent Application Publication
(10) Pub. No.: US 2014/0129513 A1
(43) Pub. Date: May 8, 2014

(54) SUBSET CALCULATION BY IDENTIFYING CALCULATED VALUES WITH MODIFIED PARAMETERS

(71) Applicant: Callidus Software Incorporated, Pleasanton, CA (US)

(72) Inventors: Fokkuong Cheang, Union City, CA (US); Boris Milrud, Castro Valley, CA (US)

(73) Assignee: Callidus Software Incorporated, Pleasanton, CA (US)

(21) Appl. No.: 14/065,262

(22) Filed: Oct. 28, 2013

Related U.S. Application Data
(63) Continuation-in-part of application No. 13/672,401, filed on Nov. 8, 2012.
Application No. 13/672,401 is a continuation-in-part of application No. 13/725,263, filed on Dec. 21, 2012.
Application No. 13/725,263 is a continuation of application No. 13/672,401, filed on Nov. 8, 2012.

(51) Int. Cl. G06F 17/30

(52) U.S. Cl. CPC G06F 17/30345
USPC 707/609

(57) ABSTRACT

In some embodiments, a method includes determining a first subset of a plurality of calculated values. Each calculated value of the first subset may comprise at least one modified parameter, in some instances. The method may further, in some embodiments, include determining a second subset of the plurality of calculated values. Each calculated value of the second subset may depend from a calculated value in the first subset, in some embodiments. In some embodiments, the method may also include: calculating updated values for the first subset based on the at least one modified parameter, and calculating updated values for the second subset based on the updated values for the first subset.

### RELATED APPLICATIONS

This application is a continuation-in-part and claims the benefit and priority to U.S. patent application Ser. No. 13/672,401, filed on Nov. 8, 2012, disclosure of which is incorporated by reference in its entirety by reference. Moreover, this application is a continuation-in-part and claims the benefit of and priority to U.S. patent application Ser. No. 13/725,263, filed on Dec. 21, 2012, which is a continuation of U.S. patent application Ser. No. 13/672,401, filed on Nov. 8, 2012, the disclosures of which are incorporated in their entirety by reference.

### BACKGROUND

In general, data management systems store, process and calculate values for millions of inputs, data and information received from multiple sources, such as business organizations. Information received from a wide variety of sources may be used for various calculations, e.g., calculating sales commission, calculating performance of different groups, calculating future sales projections, etc. However, the sheer volume of data and the wide variety of inputs may require a long time to be calculated, e.g., it may take hours, days or even months to process. In practice, these inputs are not static and may change over time. For example, a sales team may sell more units, or the position of a sales person may change, or a commission associated with a given product for a certain group may change, or a completed sale of a product may be returned, to name a few. Conventionally, to account for these modifications, a data management system had to reprocess and recalculate the entire data set of calculated values with the newly modified inputs. Recalculating the entire data set with the modified inputs is not only resource intensive, but it also takes a long time and is highly inefficient.

### SUMMARY

Accordingly, a need has arisen to efficiently determine the inputs that have changed in previously calculated data sets. It is appreciated that determining and recalculating the calculated values affected by the changed inputs may occur without having to recalculate the entire data set. It will become apparent to those skilled in the art after reading the detailed description that the embodiments described herein satisfy the above mentioned needs.

According to various embodiments, a mechanism to identify and recalculate a subset of already calculated values associated with a modified parameter is provided. In some embodiments, a determination is made whether a parameter associated with an already calculated value is modified. A parameter may be the position of an individual in a business organization, a business rule, e.g., rules for calculating commission, performance, etc., a business organization hierarchy, transactional data, e.g., sales, dates, returns, commission payments, etc., in some embodiments.

According to one embodiment, an already calculated value that depends on a modified parameter may be identified. For example, a commission paid to an employee may be identified in response to a change in the commission percentage of that employee. As another example, a commission paid to an employee may be identified in response to a change in the number of units sold or a change in the position of the employee. Moreover, other calculated values that depend on the calculated value with the modified parameter may be identified. For example, a commission paid to a manager may depend on the commission paid to an employee and when the commission paid to the employee is changed, the commission paid to the manager is identified and recalculated as well. As such, the mechanisms described herein, identify dependencies on the modified parameters. Accordingly, only the calculated values with dependencies on the modified parameters (either directly or indirectly) need to be recalculated. In this way, a subset of previously calculated values is recalculated rather than an entire set of previously calculated values. As such, the mechanisms described herein reduce the amount of time and resources utilized for recalculation.

In some embodiments, a method may comprise determining whether a parameter associated with a first calculated value, stored in a memory component, is modified, and in response to determining that the parameter is modified, identifying a first and a second portion of the first calculated value. In some embodiments, the first portion may be associated with the modified parameter, and the second portion may be a portion other than the first portion. The method may further comprise calculating the first portion based on the modified parameter to form an updated first portion, and calculating an updated first calculated value based on the updated first portion and further based on the second portion.

In some embodiments, the method may further comprise: in response to determining that the parameter is modified, identifying a second calculated value that depends from the first calculated value, calculating an updated second calculated value based on the first updated calculated value. In some embodiments, identifying the second calculated value may comprise identifying a portion of the second calculated value associated with the first calculated value.

In some embodiments, determining whether the parameter is modified may be based on a modification indicator attribute associated with the parameter. In some embodiments, the determination may comprise: comparing a timestamp associated with the first calculated value to a timestamp associated with the parameter, and in response to a mismatch between the timestamp associated with the first calculated value and the timestamp associated with the parameter, determining that the parameter is modified.

In some embodiments, the first calculated value and the updated first calculated value is associated with a commission payment, and the parameter is selected from a group consisting of a position of an individual within a business organization, rules to calculate calculated values, employee's hierarchical relationships within the business organization, and a transactional data related to sales of products and/or services. The method may further comprise determining a difference between a value of the modified parameter and a value of the parameter before being modified, in some embodiments. In some instances, calculating the updated first calculated value is based on the difference.

In some embodiments, a non-transitory computer-readable storage medium having stored thereon, computer executable instructions that, if executed by a processor may cause the processor to perform a method comprising determining a first subset of a plurality of calculated values. Each calculated value of the first subset may comprise at least one modified parameter. In some embodiments, the method may further include determining a second subset of the plurality of calculated values. In some embodiments, each calculated value of the second subset depends on a calculated value in the first subset. The method, in some embodiments, may comprise calculating updated values for the first subset based on the at least one modified parameter, and calculating updated values for the second subset based on the updated values for the first subset.

In some embodiments, determining the second subset may comprise identifying calculated values other than the calculated values of the first subset. In some embodiments, a portion of the identified calculated values is based on at least one calculated value of the first subset. In some embodiments, at least one modified parameter is selected from a group consisting of a position of an individual within a business organization, rules to calculate calculated values, employees hierarchical relationships within the business organization, and transactional data related to sales of products and/or services.

Calculating updated values for the first subset may comprise identifying a first and a second portion for each calculated value of the first subset, in some embodiments. In some embodiments, the first portion may be associated with the at least one modified parameter, and the second portion may be a portion other than the first portion. In some embodiments, calculating updated values for the first subset may further comprise calculating the first portion based on the at least one modified parameter to form an updated first portion, and calculating an updated calculated value for each calculated value based on the updated first portion and further based on the second portion.

In some embodiments, a calculated value from the second subset may comprise a first portion and a second portion. A first portion may depend from the first subset, and the second portion may be independent from the first subset, in some embodiments. In some embodiments, the first portion may be recalculated based on the updated values from the first subset and no recalculation may be performed for the second portion to form updated value for the calculated value of the second subset.

In some embodiments, determining the first subset of the plurality of calculated values may comprise comparing a timestamp associated with a first calculated value of the plurality of calculated values to a timestamp associated with a parameter of the first calculated value. The determination of the first subset of the plurality of calculated values may further comprise in response to a mismatch between the timestamp associated with the first calculated value and the timestamp associated with the parameter of the first calculated value, determining that the parameter of the first calculated value is modified and determining that the first calculated value is part of the first subset of the plurality of calculated value. In some embodiments, determining the second subset of the plurality of calculated values may be based on a dependency attribute associated with a calculated value in the first subset.

In some embodiments, a method may comprise determining whether to recalculate a calculated commission payment value of one position from a plurality of calculated commission payment values associated with a plurality of positions within a business organization. In some embodiments, the determination may be based on whether a parameter used to calculate the commission payment value is modified. The plurality of calculated commission payment values may be stored in a memory component, in some embodiments. The method may further comprise: determining whether a calculated commission payment value of another position of the plurality of positions depends from the calculated commission payment value of the one position, and forming a subset of commission payment values associated with the one position and the another position to be recalculated, in some embodiments.

In some embodiments, the method may further comprise: recalculating a commission payment for the one position based on the modified parameter, and recalculating a commission payment for the another position based on the recalculated commission payment of the one position. In some embodiments, determining whether the another position depends from the one position is based on a dependency relationship between the one position and the another position.

In some embodiments, determining whether a parameter is modified may further comprise: comparing a timestamp associated with the calculated commission payment value of the one position to a timestamp associated with the parameter. The method may further comprise in response to a mismatch between the timestamp associated with the calculated commission payment value of the one position and the timestamp associated with the parameter, determining that the parameter is modified, in some embodiments.

In some embodiments, the method may further comprise: prior to determining whether to recalculate, determining whether the plurality of calculated commission payment values exist, and in response to determining that the plurality of calculated commission payment values do not exist, accessing an initial set of parameters stored in a memory component. In some embodiments, the initial set of parameters may be associated with the business organization. In some embodiments, the initial set of parameters may be used to calculate the plurality of commission payment values associated with the plurality of positions.

These and other features and aspects of the embodiments may be better understood with reference to the following drawings, description, and appended claims.

### BRIEF DESCRIPTION OF DRAWINGS

FIG. 1 shows a system for calculating values in accordance with an embodiment.

FIGS. 2A-2C show exemplary interactions for calculating values and recalculating a subset of the initial set in accordance with an embodiment.

FIGS. 3A-3B show an exemplary method to calculate values in accordance with an embodiment.

FIG. 4 shows a block diagram of an exemplary computer system in accordance with one embodiment.

FIG. 5 shows a block diagram of another exemplary computer system in accordance with one embodiment.

### DETAILED DESCRIPTION

References will now be made in detail to various embodiments, examples of which are illustrated in the accompanying drawings. The embodiments described are for illustrative purposes only and it will be understood that these various embodiments are not intended to limit the scope. On the contrary, the embodiments are intended to cover alternatives, modifications, and equivalents, which may be included within the scope of the appended Claims. Furthermore, in the following detailed description of various embodiments, numerous specific details are set forth in order to provide a thorough understanding of the claims. However, it will be evident to one of ordinary skill in the art that the claims may be practiced without these specific details. In other instances, well known methods, procedures, components, and circuits have not been described in detail as not to unnecessarily obscure aspects of the embodiments.

Some sections of the detailed descriptions that follow are presented in terms of procedures, logic blocks, processing, and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of operations or steps or instructions leading to a desired result. The operations or steps are those utilizing physical manipulations of physical quantities. Usually, although not necessarily, these quantities take the form of electrical or magnetic signals capable of being stored, transferred, combined, compared, and otherwise manipulated in a computer system or computing device. It has proven convenient at times, principally for reasons of common usage, to refer to these signals as transactions, bits, values, elements, symbols, characters, samples, pixels, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present disclosure, discussions utilizing terms such as “receiving,” “converting,” “transmitting,” “storing,” “determining,” “identifying,” “calculating,” “recalculating,” “sending,” “querying,” “providing,” “accessing,” “associating,” “configuring,” “initiating,” “modifying,” “updating,” “comparing,” “forming,” or the like, refer to actions and processes of a computer system or similar electronic computing device or processor. The computer system or similar electronic computing device manipulates and transforms data represented as physical (electronic) quantities within the computer system memories, registers or other such information storage, transmission or display devices.

A value may be calculated based on different parameters. For example, a commission value may be calculated based on commission percentage, position of the individual within an organization, number of units sold, and/or business rules (e.g., commission percentage for that position, rules to calculate a commission payment, performance, etc.). The calculated values may be stored in a data management system. For example, the data management system may store a plurality of calculated commission values associated with different positions in an organization. In practice, the parameters used to calculate the calculated values are not static and change over time. For example, more units may be sold, a number of already sold units may be returned, or a percentage for a given product may be changed, etc., thus, the commission paid on those products may be changed.

According to one embodiment, a subset of calculated values of the plurality of calculated values with at least one modified parameter is identified. The data management system processes the subset of calculated values based on the modified parameters to form the new calculated values. In other words, the data management system only recalculates new values for the subset based on the modified parameters. It is appreciated that calculated values that are not dependent on modified parameters are not changed and are not recalculated. In other words, only a subset of the values is recalculated. It is appreciated that in one embodiment, a parameter modification associated with a calculated value may affect other calculated values because of their dependency. As such, in some embodiments described herein, values depending on the newly calculated values are also recalculated.

In an illustrative example, a data management system may be configured to calculate and store commission payments for different positions (e.g., sales representative, manager, vice president, director, etc.) of a business organization. The data management system may be configured to receive parameter values, e.g., transactional data about a sale of a service or a product, business rules to use in calculating the commission payments, and/or business organization parameters defining hierarchical relationships within the business organization, etc., to calculate the commission payment values for different positions of the business organization. In this example, the commission management system may calculate 2-3 million commission payment values per fiscal quarter for 7000 positions, which may take hours if not days to process.

The data management system may also receive new and/or modified parameters after the commission payment values have been calculated because the parameters may change over the course of a fiscal period or new parameters may be added. For example, transactional data for the sale of a tennis racket may need to be changed from $300 to $200 due to a typographical error when the transactional data was initially entered or in order to reflect a discounted sale toward the end of the season to reduce inventory. In this scenario, using the mechanisms described herein, it may be determined that two position parameters, e.g., a sales representative A and manager B, are associated with the tennis transaction, and whose sales commission payments need to be recalculated. The data management system recalculates the commission payment values for the sales representative A and manager B based on the $200 sale. Recalculation of a small subset of commission payment values takes substantially less time in comparison to recalculating the commission payment values for every position and the entire data set. Thus, recalculation time, the amount of calculation redundancies, and the amount of CPU resource utilization are reduced.

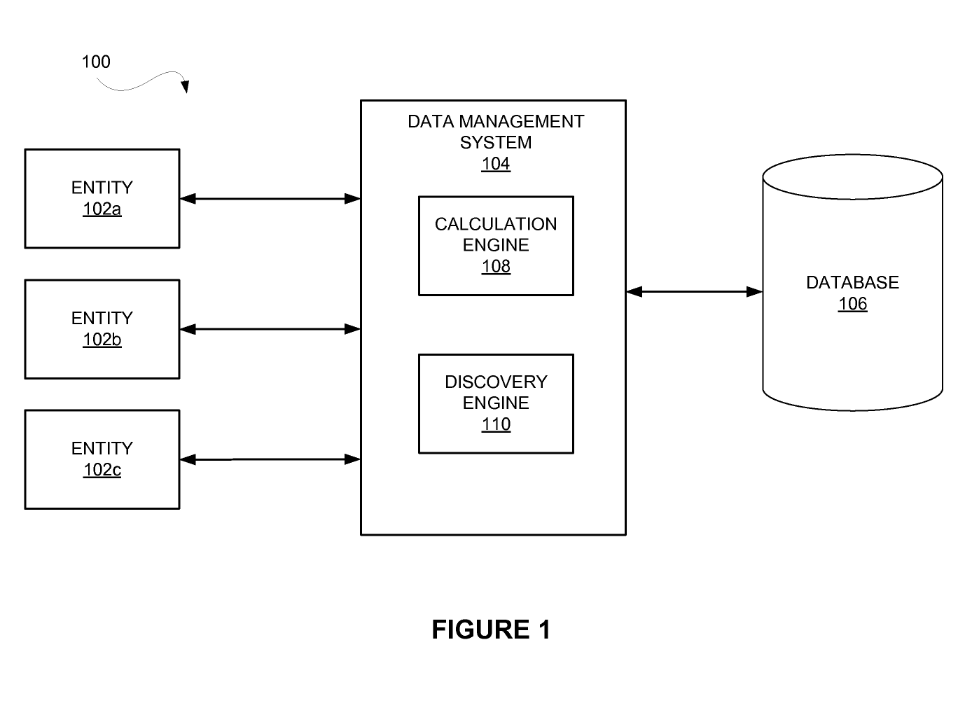

Referring now to FIG. 1, a system for calculating values in accordance with an embodiment is shown. In some embodiments, system 100 includes a plurality of entities 102a-102c, a data management system 104, and a database 106. It is appreciated that one or more devices, e.g., a computing device, a server, a portable mobile device (e.g., tablet, mobile phone, a laptop), or some combination thereof, may be associated with each entity of the plurality of entities 102a-102c. The entities 102a-102c transmit information (hereinafter referred to as parameters), e.g., sales data, commission values, transaction data, etc., to the data management system 104. Based on the received parameters, the data management system 104 determines whether an initial set of values needs to be calculated or whether a subset of the initial set of values needs to be recalculated. The calculation results of the data management system 104 are subsequently stored in the database 106.

Each entity may represent a business organization. In some embodiments, the one or more devices associated with an entity, e.g., entity 102a, may transmit an initial set of parameter values (entity defined or system defined), in a batch, by a specific time period, e.g., the end of a second month of a fiscal quarter, to the data management system 104. On the other hand, devices associated with entity 102b may be configured to transmit batches of parameters every three months over the course of one year. In some embodiments, devices associated with entities 102a-102c may transmit parameters to the data management system 104 when a parameter is created. It is appreciated that devices associated with entities 102a-102c may transmit parameters in response to a request from the data management system 104. In some embodiments, the manner in which the entities 102a-102c transmit parameters to the data management system 104 may be based on the terms of a service-level agreement (SLA) between the entities 102a-102c and the data management system 104.

The set of parameters, in some instances, may include a parameter related to a position of an individual in a business organization, business rules that define rules to calculate values such as commission values, position hierarchical relationships within a business organization, transactional data associated with a product/service, etc. A position parameter may include information regarding the title of the position (e.g., sales representative, manager, etc.), the department associated with the position, compensation associated with the position, commission percentage associated with the position, etc. A position hierarchical organization parameter may define employee positions that depend from one another, e.g., may define which positions report to other positions such as a sales representative reporting to a manager, who reports to a director within a business organization. According to one embodiment, a business rule may be used to calculate commission payments for a business organization, bonuses, base pay calculations, etc. It is appreciated that the parameters described above are for illustration purposes only and are not intended to limit the scope of the embodiments.

The initial set of parameters may be used by the data management system 104 to calculate the initial values, e.g., commission values, billing values, financial statements/bookkeeping of profit and loss values, performance evaluation, etc. The calculated initial values may be associated with a specific time period, e.g., a fiscal quarter. The calculated initial values may be transmitted to the database 106 to be stored. It is appreciated that in one embodiment, the initial set of parameters may also be transmitted to the database 106 to be stored.

It is appreciated that a modification to some of the initial set of parameters may occur after the initial values have been calculated. To account for these modifications, the data management system 104 may be configured to determine whether one or more of the calculated initial values need to be recalculated based on these modifications.

The data management system 104 may include a calculation engine 108 and a discovery engine 110. The discovery engine 110 is configured to determine whether a calculation of all the initial values or a recalculation of a subset of initially calculated values needs to be performed for an entity, such as entities 102a-102c. The calculation engine 108 calculates values based on one or more parameters and further based on the determination by the discovery engine 110. For example, the calculation engine 108 may recalculate a subset of calculated values with the modified parameters based on the determination by the discovery engine 110. It is further appreciated that the calculation engine 108 may calculate initial values, e.g., an entire set, in response to receiving a request. In some embodiments, the calculation engine 108 may calculate values as disclosed in U.S. patent application Ser. No. 13/725,263, filed on Dec. 21, 2012, and U.S. patent application Ser. No. 13/672,401, filed on Nov. 8, 2012, which are incorporated herein in its entirety and for all purposes.

According to one embodiment, the discovery engine 110 may determine whether the received parameters are the initial set of parameters for a certain period, e.g., end of the fiscal year, end of the quarter, user specified period, etc., or whether the received parameters are modifications to the initial set of parameters. The discovery engine 110 may further determine whether values have been calculated for the initial set of parameters. In other words, the discovery engine 110 may determine whether an initial set of calculated values exist for an entity. In one embodiment, the discovery engine 110 may cause the calculation engine 108 to calculate the initial set of values to form an initial set of calculated values if a determination is made that values associated with the initial set of parameters have not been calculated or that they do not exist. The determination by the discovery engine 110 may automatically be initiated in response to receiving the parameters or it may be initiated at a predetermined time, e.g., every 30 minutes, every hour, once a day, once a month, once every fiscal quarter, in accordance with some user/system defined schedule, etc.

According to an embodiment, the discovery engine 110 identifies the calculated values, whether they are initially calculated values or whether they are subsequently calculated values of the initially calculated values, that are impacted by the modified parameters if it is determined that the received parameters are modifications and updates to the initial set of parameters. In other words, calculated values, whether they are initially calculated values or whether they are subsequently calculated values of the initially calculated values that depend on the modified parameters are identified. Accordingly, the discovery engine 110 identifies a subset of an initial set of calculated values where their values depend on the parameters that are now modified. According to one embodiment, the discovery engine 110 may further identify other calculated values, whether they are initially calculated values or they are subsequently calculated values of the initially calculated values that depend on the identified subset. According to one embodiment, the discovery engine 110 may cause the calculation engine 108 to recalculate values for the identified subset and further for values dependent on the identified subset using the received parameters. In other words, once the subset of calculated values and values dependent therefrom are identified, the calculation engine 108 may recalculate those values based on the modified parameters.

It is appreciated that discussion of FIG. 1 with one database is exemplary and is not intended to limit the scope of the embodiments. For example, more than one database may be used. It is further appreciated that the number of entities shown is exemplary and not intended to limit the scope of the embodiments. In some embodiments, more than three or fewer than three entities may interact with the data management system described herein.

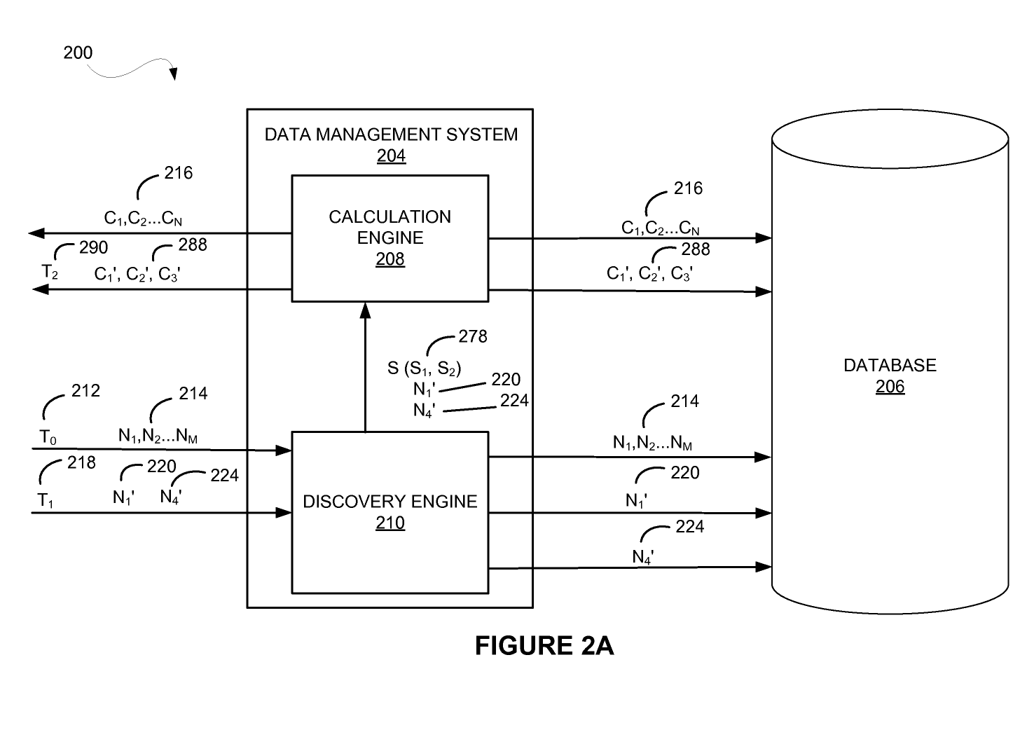

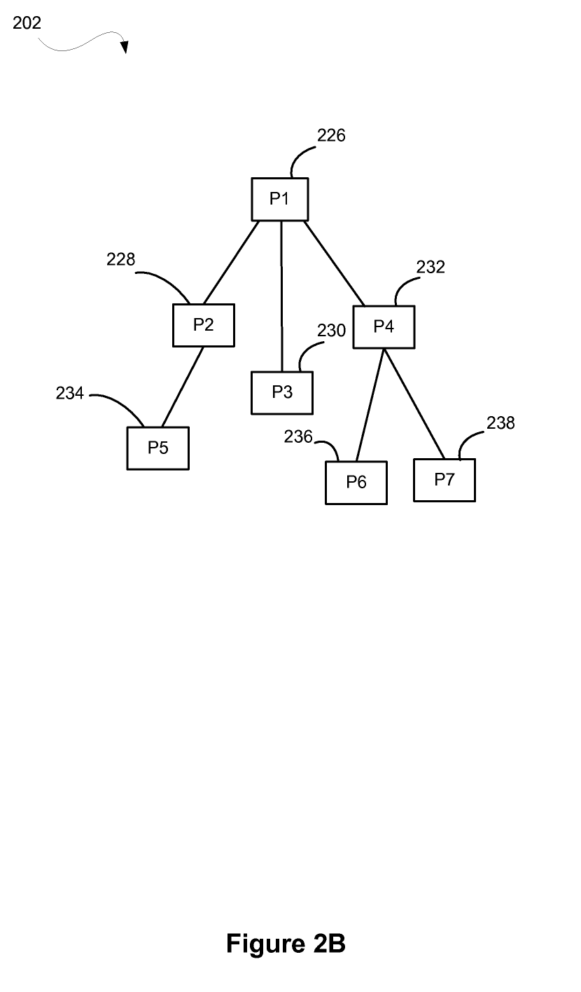

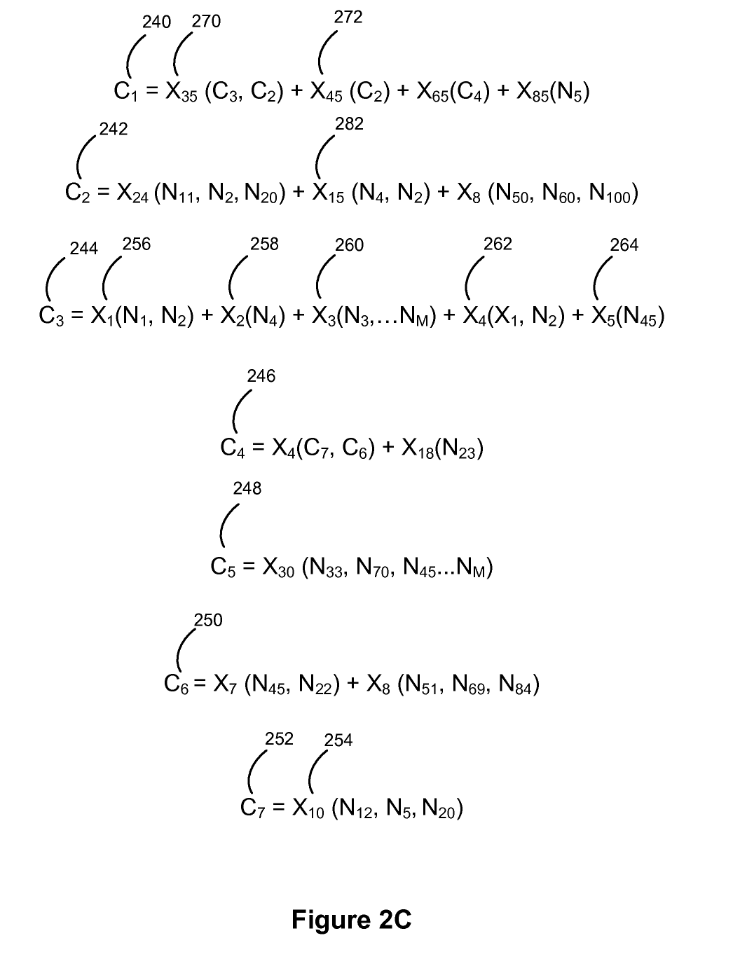

Referring to FIGS. 2A-2C, exemplary interactions for calculating values and recalculating a subset of the initial set in accordance with an embodiment are shown. In FIG. 2A, exemplary calculation of initial commission values and recalculation of a subset of initially calculated commission values are shown. It is appreciated that commission values may be calculated for positions (e.g., sales representative, manager, director, etc.) associated with a business organization. FIG. 2B illustrates an exemplary business hierarchy of some positions of the business organization, and FIG. 2C illustrates exemplary parameters used to calculate commission values corresponding to the positions illustrated in FIG. 2B. It is appreciated that exemplary embodiments described with respect to the commission values are illustrative in nature and not intended to limit the scope of the embodiments.

In one embodiment, system 200 includes a data management system 204 and a database 206. The data management system 204 may include a discovery engine 210 and a calculation engine 208. In this exemplary embodiment, data management system 204, database 206, the calculation engine 208, and the discovery engine 210, function substantially similar to the data management system 104, database 106, the calculation engine 108, and the discovery engine 110 respectively.

The discovery engine 210, at time T₀ 212, receives a set of parameters, e.g., N₁, N₂ . . . N_{M} 214 from a business organization, such as Acme Co, associated with positions within the company. The set of parameters 214 may include parameters such as transactional data (e.g., a sale value of a product, returns), business rules (e.g., commission percentage for a position, rules to calculate a commission payment), definition of organizational relationships within the business organization, information associated with a position within the organization (e.g., territory coverage of a position, sales goals), etc. It is appreciated that time Tₒ 212 may be a time when the set of parameters 214 was created or some predetermined time based on user and/or system defined schedule, e.g., end of the quarter, end of the fiscal year, etc., or when the data management system 204 requests for the set of parameters 214.

In one embodiment, after the discovery engine 210 receives the set of parameters 214, the discovery engine 210 transmits the set of parameters 214 to database 206 for storage. The discovery engine 210 may determine whether the received set of parameters 214 is the first set of parameters received in a certain period, e.g., fiscal year, quarter, month, etc., or an update thereof. According to one embodiment, timestamps associated with the parameters, e.g., parameters 214 and parameters previously stored in the database 206, may be used to determine whether the received parameters are the initial set of parameters in a given period or whether the received parameters are updates to the initial set of parameters. In one embodiment, the received set of parameters 214 may be identified as the initial set of parameters if their timestamps predate other parameters received within the given period. In one exemplary embodiment, the received set of parameters 214 may be identified as modified parameters if their respective timestamps postdate timestamps of previously received parameters within the given period. In one embodiment, a mismatch between the timestamps of the received set of parameters 214 and the time stamps of the parameters stored in the database 106 within the given period may indicate that a parameter has been modified.

The discovery engine 210 may determine whether a set of commission values associated with the set of parameters 214 exists. The discovery engine 210 may cause the calculation engine 208 to calculate commission values for the set of parameters 214 if it is determined that the set of parameters 214 is the initial set of parameters in that period and if no commission value has been calculated for the set of parameters 214. On the other hand, the discovery engine 210 may determine whether one or more of the previously calculated commission values within the given period needs to be recalculated if it is determined that the set of parameters 214 is not the initial set of parameters but rather modifications to previously received parameters within the given period.

In some embodiments, the calculated commission values are times tamped based on the timestamp of the parameters used to calculate the commission values. As such, commission values calculated from the initial set of parameters in a given period may have the same timestamp as the initial set of parameters. It is, therefore, appreciated that in some embodiments, the timestamp of the calculated commission values may be compared to the timestamps of the received set of parameters 214 in order to determine whether the set of parameters 214 is a modification of a previous set of parameters.

According to one embodiment, the discovery engine 210 sends a request to the calculation engine 208 to calculate commission values based on the set of parameters 214 if it is determined that the received set of parameters 214 is the initial set of parameters in that period and if a data set of commission values does not exist for that period. The calculation engine 208 calculates the commission values C₁, C₂ . . . C_{N} 216, where each commission value may correspond to a different position at Acme Co. According to one embodiment, the calculated commission values 216 may be transmitted to a display device for rendering. In some embodiments, the calculated commission values 216 may be transmitted to the database 206 for storage. In this example, the commission values 216 may be stored with a timestamp T₀ 212 to represent correspondence between the commission values 216 and the received parameters 214.

It is appreciated that the discussion of the timestamp of the commission values 216 coinciding with the timestamp of the set of parameters 214 is exemplary and is not intended to limit the scope of the embodiments described herein. In some embodiments, the timestamp associated with the commission values 216 may be based on an internal clock of database 206. In some embodiments, the commission values may be associated with a metadata, a flag, and/or some other temporal indicator other than a timestamp.

Over time, the parameters may be modified and changed. For instance, the discovery engine 210 may receive the modified parameters after a certain period of time after the set of parameters 214 is received. For example, at time T₁ 218, the discovery engine 210 may receive a modification N₁′ 220 to N₁ parameter value. The received parameter N₁′ 220 is identified as a modification to previous parameter N₁ within the given period by using timestamps, for example, as discussed above. In this example, modified parameter N₁′ 220 may represent a change in a transactional data, such as a modification to the sale price of a tennis racket from $300 to $200. Similarly at time T₁ 218, the discovery engine 210 may receive another modified parameter value, e.g., N₄′ 224, which may represent an update to the commission percentage from 10% to 12% for one or more positions within Acme Co. After receiving the modified parameters, the discovery engine 210 may transmit the modified parameters N₁′ 220 and N₄′ 224 to the database 206 for storage.

In order to account for the modified parameters, in some embodiments, the discovery engine 210 may determine which of the calculated commission values 216 is impacted by the modified parameters N₁′ 220 and N₄′ 224. For example, the discovery engine 210 may identify some of the calculated commission values that depend on the modified parameters. Accordingly, the discovery engine 210 identifies the calculated commission values that are impacted by the modified parameters and forms a subset, e.g., S 278, of the calculated commission values 216. The formed subset S 278 identifies the commission values that need to be recalculated. The discovery engine 210 may cause the calculation engine to recalculate commission values associated with the identified subset S 278 based on the modified parameters N₁′ 220 and N₄′ 224. As such, updated calculated commission values are formed. The updated calculated commission values may be transmitted from the calculation engine 208 to the database 208 for storage.

To illustrate the discovery of a subset of commission values impacted by modified parameters N₁′220 and N₄′ 224 and the recalculation of the subset, references will be made to FIGS. 2B and 2C in conjunction with FIG. 2A. As noted above, FIGS. 2B and 2C illustrate a segment of a business hierarchy 202 of Acme Co. and corresponding commission values of some positions within Acme Co. FIG. 2B illustrates seven positions out of a plurality or some N number of positions within Acme Co. to simplify the discussion. Specifically, in FIG. 2B, the business hierarchy includes position P1 226 and three subordinate positions P2 228, P3 230 and P4 232. Further, position P2 228 has a subordinate position P5 234, and position P4 232 has two subordinate positions P6 236 and P7 238. FIG. 2C shows commission values C₁ 240, C₂ 242, C₃ 244, C₄ 246, C₅ 248, C₆ 250, and C₂ 252 from the commission values 216 that correspond to positions P1 226, P2 228, P3 230, P4 232, P5 234, P6 236, and P7 238, respectively. FIG. 2C further illustrates parameters from the set of parameters 214 used to calculate the commission values.

In some embodiments, the discovery engine 210 may determine which commission values are impacted by the modified parameters N₁′ 220 and N₄′ 224. The discovery engine 210 may evaluate the positions from the bottom-up or from the top-down to identify positions impacted by the modified parameters N₁′ 220 and N₄′ 224. However, it is appreciated that the embodiments are not limited to bottom-up or top-down evaluation. For example, evaluation may begin with any position, regardless of its hierarchical position, and its dependency and dependencies of other positions may be traced.

In this example, commission value C₇ 252 for position P7 238 may be evaluated first to determine whether it is impacted by a modified parameter. As FIG. 2C illustrates, commission value C₇ 252 is calculated based on function X₁₀ 254. Here, function X₁₀ 254 may be a user/Acme Co./system defined function that may be used to: calculate a percentage of a commission value for meeting a fiscal quarter quota goal, calculate a portion of a commission value based on a type of product or service sold, a deduction from a portion of a commission value based on the number of discounts offered, etc. In this example, function 254 uses parameters N₁₂, N₅ and N₂₀ as its input to calculate commission value C₇ 252.

The discovery engine 210 determines that the commission value C₇ 252 associated with position P7 238 is not impacted because the modified parameters N₁′ 220 and N₄′ 224 are not the input parameters for calculating C₇ 252. In a similar fashion, the discovery engine 210 may select another position from the business hierarchy 202 to evaluate. This process may continue until all positions and their corresponding commission values are evaluated. Similar to commission value C₇ 252, it is determined that commission values C₄ 246, C₅ 248 and C₆ 250 are not impacted by the modified parameters N₁′ 220 and N₄′ 224.

In contrast, the discovery engine 210 may identify that the calculated commission values C₃ 244 and C₂ 242 to form a first subset, e.g., S₁, that are impacted by the modified parameters N₁′ 220 and N₄′ 224. For example, the discovery engine 210 may determine that functions X₁ 256, X₂ 258, X₃ 260, and X₄ 262 use parameters N₁ and N₄ to calculate the commission value C₃ 244, which are now modified to parameters N₁′ 220 and N₄′ 224. Similarly, the discovery engine 210 may determine that function X₁₅ 282 uses parameter N₄ to calculate commission value C₂ 242, which is now modified to parameter N₄′ 224. Accordingly, the discovery engine 210 forms a first subset S₁, identifying that commission values C₃ 244 and C₂ 242 need to be recalculated.

In some embodiments, the subset of commission values impacted by a modified parameter may be identified based on an attribute associated with the modified parameter itself. For example, modified parameter N₁′ 220 may be stored in database 208 with a unique identifier that identifies commission value C₃ 244 and/or position P3 230 as impacted by modified parameter N₁′ 220. In another example, modified parameter N₄′ 224 may be associated with a unique identifier that identifies commission values C₂ 242 and C₃ 244 that are impacted by modified parameter N₄′ 224. Accordingly, commission values C₂ 242 and C₃ 244 are identified to form the first subset S₁, identifying the commission values that need to be recalculated.

It is further appreciated that recalculating commission values for positions identified from the first subset may impact the commission values of other positions within Acme Co. due to dependencies. For example, the discovery engine 210 may determine that functions X₃₅ 270 and X₄₅ 272 of commission value C₁ 240 are based on commission values C₂ 242 and C₃ 244. As such, the discovery engine 210 identifies commission value C₁ 240 as a second subset, e.g., S_{z}, that is dependent on the updated commission values of the first subset S₁. In some instances, the dependency relationship among positions and/or commission values may be identified using relationship attribute, e.g., metadata, unique identifiers, etc., associated with a position and/or a commission value. Therefore, the discovery engine 210 forms the subset S 278 that includes the first subset and the second subset, where subset S 278 identifies commission values that need to be recalculated due to parameter modifications.

The discovery engine 210 may transmit the subset 278 along with the modified parameters N₁′ 220 and N₄′ 224 to the calculation engine 208 to recalculate the identified commission values, C₁ 240, C₂ 242, and C₃ 244 based on the modified parameters N₁′ 220 and N₄′ 224. In one embodiment, the calculation engine 208 may calculate updated commission value C₃ 244 by recalculating commission value C₃ 244 in its entirety, e.g., recalculating functions X₁ 256, X₂ 258, X₃ 260, X₄ 262 and X₅ 264. It is appreciated that functions X₁ 256, X₂ 258, and X₄ 262 are updated using modified parameter values N₁′ 220 and N₄′ 224, while the remaining functions are updated using parameters from the set of parameters 214. Commission value C₂ 242 may be updated in a similar fashion. It is appreciated that in some embodiments, instead of recalculating commission values in their entirety, only portions of the commission values that are impacted by the modified parameters may be recalculated. For example, in recalculating C₃ 244, functions X₃ 260, and X₅ 264 may not be recalculated because they are not impacted by the modified parameters N₁′ 220 and N₄′ 224. It is appreciated that C₁ 240 may be recalculated based on C₂ 242, and C₃ 244 either in its entirety or partially, as described above. As such, the updated commission values C₁′, C₂′, and C₃′ 288 are formed.

The calculation engine 208 may transmit the updated commission values 288 to the database 206 for storage. It is appreciated that in one embodiment, the updated commission values 288 may be given a timestamp associated with the modified parameters, e.g., T₁ 218. However, it is appreciated that the updated commission values 288 may be given a timestamp other than the timestamp associated with the modified parameters, e.g., T₂ 290. In some embodiments, the calculation engine 208 may transmit the updated commission values 288 to a display device for rendering.

It is appreciated, in view of the examples illustrated above, that system 200 provides a mechanism to identify previous calculated values impacted by modified parameters. Accordingly, only a subset of the previously calculated values that are impacted by the modified parameters need to be recalculated whereas the remaining calculated values are unchanged, without recalculation. Thus, processing time and resource utilization is improved.

It is appreciated that FIGS. 2A-2C discussion of two modified parameters is exemplary and is not intended to limit the scope of the embodiments described herein. In some embodiment, more than two or fewer than two parameters may be modified. It is further appreciated that the discussion in FIGS. 2A-2C of one dependent commission value is exemplary, and is not intended to limit the scope of the embodiments described herein. In some embodiments, more than one or less than one dependent commission value may be identified and recalculated.

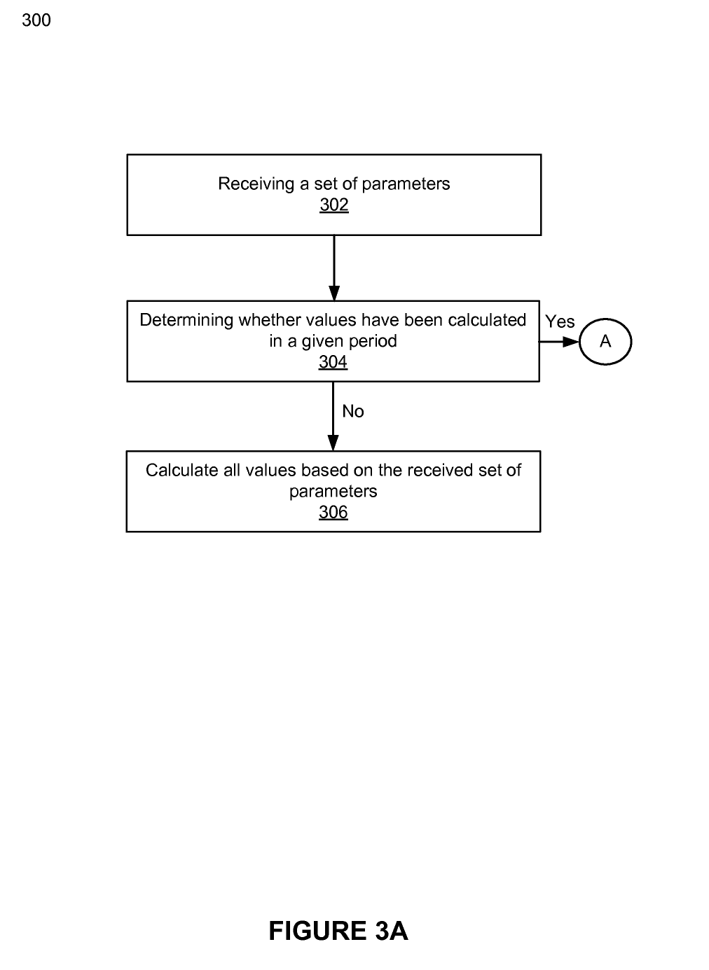

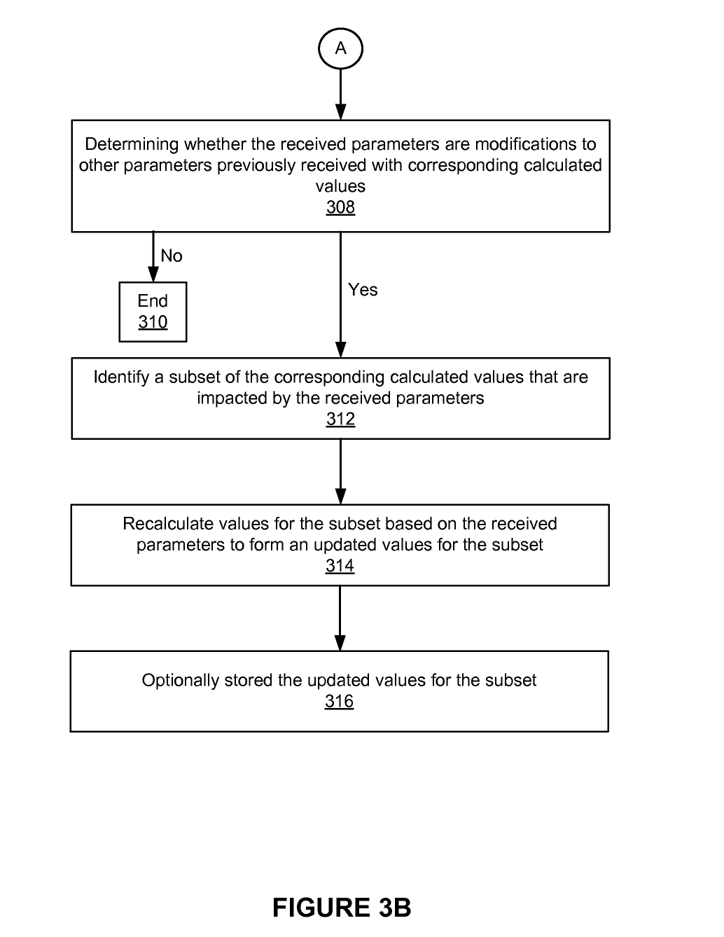

Referring now to FIGS. 3A-3B, an exemplary method to calculate values in accordance with an embodiment is shown. In some embodiments, systems of FIG. 1 and FIG. 2A may be configured to implement all or parts of method 300. In some embodiments, servers and/or computing device may be configured to implement all or parts of method 300.

At step 302, a set of parameters is received to calculate values, e.g., commission payment values. For example, the set of parameters may be transmitted by devices of entities 102a-102c and received by a data management system.

At step 304, it is determined whether values have been calculated for a given period, e.g., fiscal year, quarter, month, etc. In one instance, timestamps associated with parameters may be used to determine whether values have been calculated for a given period. In one exemplary embodiment, a database may be searched to determine whether values have been calculated in the given period. At step 306, values based on the received parameters are calculated if it is determined that values do not exist for the given period. For example, as described above, the discovery engine 210 may cause the calculation engine 208 to calculate commission values for the set of parameters 214 if it is determined that the set of parameters 214 is the initial set of parameters in that period and if no commission value has been calculated for the set of parameters 214. In one embodiment, the values may be calculated regardless of whether the received parameters are the initial set of parameters as long as the received parameters are associated with the given period. It is appreciated that according to one illustrative embodiment, the calculated values may be time stamped with the timestamp of the received parameters.

At step 308, it is determined whether the received parameters are modifications to other parameters previously received, within the given period, with corresponding calculated values if it is determined that calculated values exist in step 304. For example, timestamps associated with the received parameters, e.g., parameters 214, may be compared to the timestamps of parameters previously stored in the database 206, within the given period, to determine whether the received parameters predate or postdate the stored parameters. The received parameters may be identified as modified parameters if they postdate the previously stored parameters. In one embodiment, a mismatch between the timestamps of the received set of parameters 214 and the timestamps of the parameters stored in the database 106 within the given period may indicate that a parameter has been modified.

The process ends, at step 310, if it is determined that the received parameters are not modifications to other parameters. On the other hand, at step 312, a subset of the corresponding calculated values is identified if it is determined that the received parameters are modified parameters. The subset identifies calculated values that are impacted by the received parameters.

At step 314, values associated with the identified subset are recalculated based on the received parameters to form the updated calculated values of the subset. The values for the subset are recalculated because the received parameters are modifications to the parameters previously received that were used to calculate the values. It is appreciated that the calculation may be a partial recalculation or a full recalculation, as described above with respect to FIGS. 2A-2C. According to one embodiment, the updated values of the subset are time stamped with the timestamp of the received parameters. However it is appreciated that time stamping the updated calculated values based on the received parameters is exemplary and not intended to limit the scope of the embodiment. At step 316, the updated calculated values of the subset may optionally be stored, e.g., in a database. It is appreciated that the process described herein may continue as parameters are modified and updated overtime.

Accordingly, the embodiments described herein recalculate a subset of values rather than all the values as parameters are modified and changed over time. As such, the amount of processing and the amount time required is reduced and efficiency is improved.

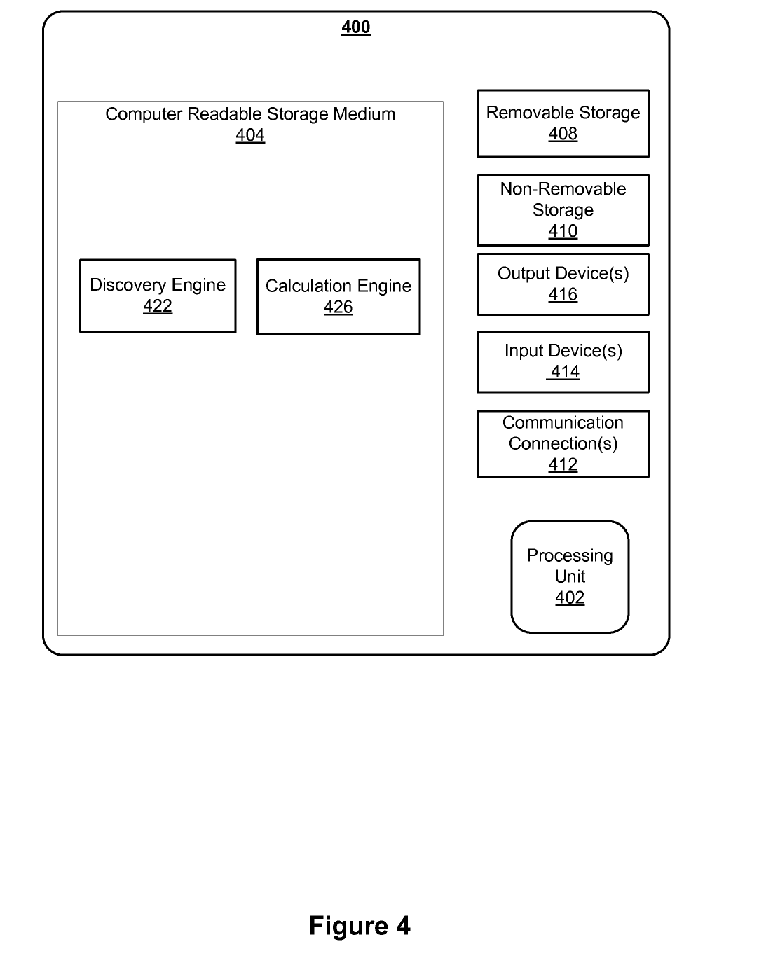

Referring now to FIG. 4, a block diagram of an exemplary computer system in accordance with one embodiment is shown. With reference to FIG. 4, an exemplary system module for implementing embodiments disclosed herein, such as the embodiments described in FIGS. 1, 2A-2C, and 3A-3B. In some embodiments, the system includes a general purpose computing system environment, such as computing system environment 400. Computing system environment 400 may include, but is not limited to, servers, desktop computers, laptops, tablets, mobile devices, and smartphones. In its most basic configuration, computing system environment 400 typically includes at least one processing unit 402 and computer readable storage medium 404. Depending on the exact configuration and type of computing system environment, computer readable storage medium 404 may be volatile (such as RAM), non-volatile (such as ROM, flash memory, etc.) or some combination of the two. Portions of computer readable storage medium 404 when executed facilitates the configuring of devices according to embodiments described herein, e.g., process 300.

Additionally in various embodiments, computing system environment 400 may also have other features/functionality. For example, computing system environment 400 may also include additional storage (removable and/or non-removable) including, but not limited to, magnetic or optical disks or tape. Such additional storage is illustrated by removable storage 408 and non-removable storage 410. Computer storage media includes volatile and nonvolatile, removable and non-removable media implemented in any method or technology for storage of information such as computer readable instructions, data structures, program modules or other data. Computer readable medium 404, removable storage 408 and nonremovable storage 410 are all examples of computer storage media. Computer storage media includes, but is not limited to, RAM, ROM, EEPROM, flash memory or other memory technology, expandable memory (e.g. USB sticks, compact flash cards, SD cards), CD-ROM, digital versatile disks (DVD) or other optical storage, magnetic cassettes, magnetic tape, magnetic disk storage or other magnetic storage devices, or any other medium which can be used to store the desired information and which can be accessed by computing system environment 400. Any such computer storage media may be part of computing system environment 400.

In some embodiments, computing system environment 400 may also contain communications connection(s) 412 that allow it to communicate with other devices. Communications connection(s) 412 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

Communications connection(s) 412 may allow computing system environment 400 to communicate over various networks types including, but not limited to, fibre channel, small computer system interface (SCSI), Bluetooth, Ethernet, Wi-Fi, Infrared Data Association (IrDA), Local area networks (LAN), Wireless Local area networks (WLAN), wide area networks (WAN) such as the internet, serial, and universal serial bus (USB). It is appreciated the various network types that communication connection(s) 412 connect to may run a plurality of network protocols including, but not limited to, transmission control protocol (TCP), user datagram protocol (UDP), internet protocol (IP), real-time transport protocol (RTP), real-time transport control protocol (RTCP), file transfer protocol (FTP), and hypertext transfer protocol (HTTP).

In further embodiments, computing system environment 400 may also have input device(s) 414 such as keyboard, mouse, a terminal or terminal emulator (either directly connected or remotely accessible via telnet, SSH, http, SSL, etc.), pen, voice input device, touch input device, remote control, etc. Output device(s) 416 such as a display, a terminal or terminal emulator (either directly connected or remotely accessible via telnet, SSH, http, SSL, etc.), speakers, LEDs, etc. may also be included.

In one embodiment, computer readable storage medium 404 includes a discovery engine 422 and a calculation engine 426. The discovery engine 422 is operable to determine a subset of calculated values to recalculate as described in FIGS. 1, 2A-2C, and 3A-3B. For example, the discovery engine 422 is configured to determine and identify previously calculated values that are impacted by a modified parameter(s) from a dataset of previously calculated values to form a subset of calculated values. The calculation engine 426 may be configured to calculate updated calculated values for the subset as described in FIGS. 1, 2A-2C, and 3A-3B. Accordingly, a subset of values is recalculated rather than the entire set.

It is appreciated that implementations according to embodiments that are described with respect to a computer system are merely exemplary and not intended to limit the scope of the embodiments. For example, embodiments may be implemented on devices such as switches and routers, which may contain application specific integrated circuits (ASICs), field programmable gate arrays (FPGAs), etc. It is appreciated that these devices may include a computer readable medium for storing instructions for implementing methods according to flow diagrams of FIGS. 3A-3B.

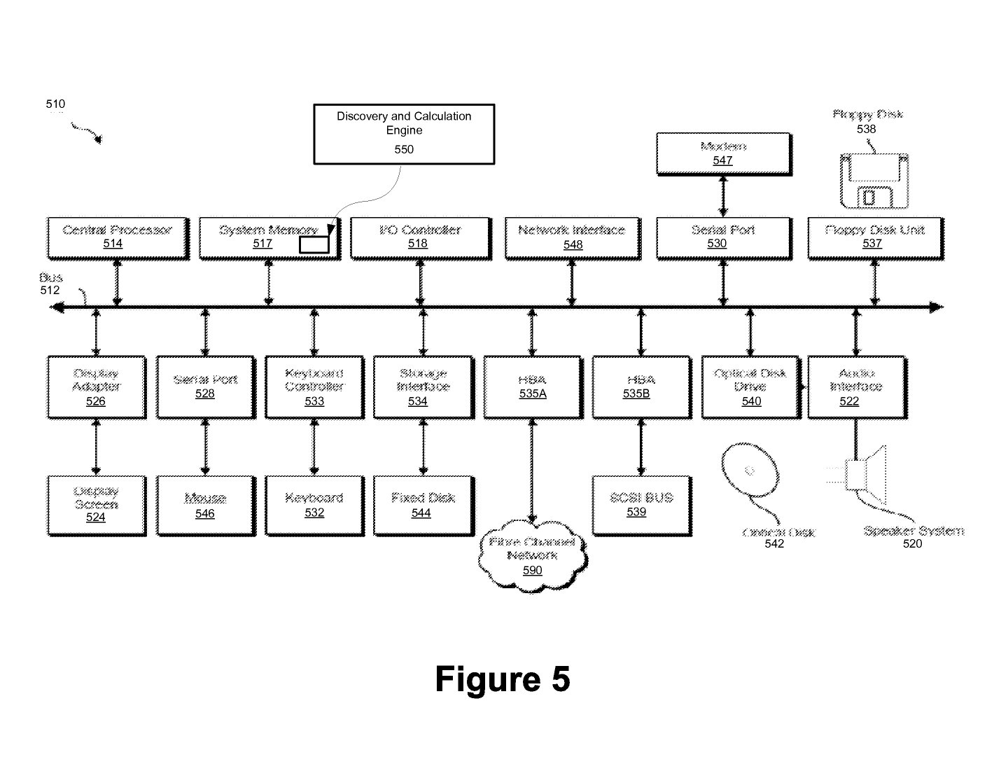

Referring now to FIG. 5, a block diagram of another exemplary computer system in accordance with one embodiment is shown. FIG. 5 depicts a block diagram of a computer system 510 suitable for implementing the present disclosure. Computer system 510 includes a bus 512 which interconnects major subsystems of computer system 510, such as a central processor 514, a system memory 517 (typically RAM, but which may also include ROM, flash RAM, or the like), an input/output controller 518, an external audio device, such as a speaker system 520 via an audio output interface 522, an external device, such as a display screen 524 via display adapter 526, serial ports 528 and 530, a keyboard 532 (interfaced with a keyboard controller 533), a storage interface 534, a floppy disk drive 537 operative to receive a floppy disk 538, a host bus adapter (HBA) interface card 535A operative to connect with a Fibre Channel network 590, a host bus adapter (HBA) interface card 535B operative to connect to a SCSI bus 539, and an optical disk drive 540 operative to receive an optical disk 542. Also included are a mouse 546 (or other point-and-click device, coupled to bus 512 via serial port 528), a modem 547 (coupled to bus 512 via serial port 530), and a network interface 548 (coupled directly to bus 512). It is appreciated that the network interface 548 may include one or more Ethernet ports, wireless local area network (WLAN) interfaces, etc., but is not limited thereto. System memory 517 includes discovery and calculations engine 550, which is operable to identify and calculate a subset of calculated values based on one or more modified parameters. According to one embodiment, the discovery and calculation engine 550 may include other modules for carrying out various tasks. It is appreciated that the discovery and calculation engine 550 may be located anywhere in the system and is not limited to the system memory 517. As such, residing within the system memory 517 is merely exemplary and not intended to limit the scope of the embodiments. For example, parts of the discovery and calculation engine 550 may be located within the central processor 514 and/or the network interface 548 but are not limited thereto.

Bus 512 allows data communication between central processor 514 and system memory 517, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components. Applications resident with computer system 510 are generally stored on and accessed via a computer readable medium, such as a hard disk drive (e.g., fixed disk 544), an optical drive (e.g., optical drive 540), a floppy disk unit 537, or other storage medium. Additionally, applications can be in the form of electronic signals modulated in accordance with the application and data communication technology when accessed via network modem 547 or interface 548.

Storage interface 534, as with the other storage interfaces of computer system 510, can connect to a standard computer readable medium for storage and/or retrieval of information, such as a fixed disk drive 544. Fixed disk drive 544 may be a part of computer system 510 or may be separate and accessed through other interface systems. Network interface 548 may provide multiple connections to networked devices. Furthermore, modem 547 may provide a direct connection to a remote server via a telephone link or to the Internet via an internet service provider (ISP). Network interface 548 provides one or more connections to a data network, which may consist of any number of other network-connected devices. Network interface 548 may provide such connection using wireless techniques, including digital cellular telephone connection, Cellular Digital Packet Data (CDPD) connection, digital satellite data connection or the like.

Many other devices or subsystems (not shown) may be connected in a similar manner (e.g., document scanners, digital cameras and so on). Conversely, all of the devices shown in FIG. 5 need not be present to practice the present disclosure. The devices and subsystems can be interconnected in different ways from that shown in FIG. 5. Code to implement the present disclosure can be stored in computer-readable storage media such as one or more of system memory 517, fixed disk 544, optical disk 542, or floppy disk 538. The operating system provided on computer system 510 may be MS-DOS®, MS-WINDOWS®, OS/2®, UNIX®, Linux®, or any other operating system.

Moreover, regarding the signals described herein, those skilled in the art will recognize that a signal can be directly transmitted from a first block to a second block, or a signal can be modified (e.g., amplified, attenuated, delayed, latched, buffered, inverted, filtered, or otherwise modified) between the blocks. Although the signals of the above described embodiment are characterized as transmitted from one block to the next, other embodiments of the present disclosure may include modified signals in place of such directly transmitted signals as long as the informational and/or functional aspect of the signal is transmitted between blocks. To some extent, a signal input at a second block can be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

It is appreciated present systems and methods can be implemented in a variety of architectures and configurations. For example, present systems and methods can be implemented as part of a distributed computing environment, a cloud computing environment, a client server environment, etc. Embodiments described herein may be discussed in the general context of computer-executable instructions residing on some form of computer-readable storage medium, such as program modules, executed by one or more computers, computing devices, or other devices. By way of example, and not limitation, computer-readable storage media may comprise computer storage media and communication media. Generally, program modules include routines, programs, objects, components, data structures, etc., that perform particular tasks or implement particular abstract data types. The functionality of the program modules may be combined or distributed as desired in various embodiments.

Computer storage media can include volatile and nonvolatile, removable and non-removable media implemented in any method or technology for storage of information such as computer-readable instructions, data structures, program modules, or other data. Computer storage media can include, but is not limited to, random access memory (RAM), read only memory (ROM), electrically erasable programmable ROM (EEPROM), flash memory, or other memory technology, compact disk ROM (CD-ROM), digital versatile disks (DVDs) or other optical storage, magnetic cassettes, magnetic tape, magnetic disk storage or other magnetic storage devices, or any other medium that can be used to store the desired information and that can be accessed to retrieve that information.

Communication media can embody computer-executable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media can include wired media such as a wired network or direct-wired connection, and wireless media such as acoustic, radio frequency (RF), infrared and other wireless media. Combinations of any of the above can also be included within the scope of computer-readable storage media.

The foregoing description, for purposes of explanation, has been described with reference to specific embodiments. However, the illustrative discussion above is not intended to be exhaustive or limit the invention to the precise forms disclosed. Many modifications and variations are possible in view of the above teachings.

What is claimed is:

1. A method comprising:
determining whether a parameter associated with a first calculated value, stored in a memory component, is modified;
in response to determining that the parameter is modified, identifying a first and a second portion of the first calculated value, wherein the first portion is associated with the modified parameter, and wherein the second portion is a portion other than the first portion;
calculating the first portion based on the modified parameter to form an updated first portion; and
calculating an updated first calculated value based on the updated first portion and further based on the second portion.

2. The method of claim 1 further comprising:
in response to determining that the parameter is modified, identifying a second calculated value that depends from the first calculated value; and
calculating an updated second calculated value based on the first updated calculated value.

3. The method of claim 2, wherein identifying the second calculated value comprises identifying a portion of the second calculated value associated with the first calculated value.

4. The method of claim 1, wherein determining whether the parameter is modified is based on a modification indicator attribute associated with the parameter.

5. The method of claim 1, wherein the determining comprises:
comparing a timestamp associated with the first calculated value to a timestamp associated with the parameter; and
determining that the parameter is modified if its timestamp postdates the timestamp associated with the first calculated value.

6. The method of claim 1, wherein the first calculated value and the updated first calculated value is associated with a commission payment, and wherein the parameter is selected from a group consisting of a position of an individual within a business organization, rules to calculate calculated values, employees hierarchical relationships within the business organization, and a transactional data related to sales of products and/or services.

7. The method of claim 1 further comprising:
determining a difference between a value of the modified parameter and a value of the parameter before being modified, and wherein calculating the updated first calculated value is based on the difference.

8. A non-transitory computer-readable storage medium having stored thereon, computer executable instructions that, if executed by a processor causes the processor to perform a method comprising:
determining a first subset of a plurality of calculated values, wherein each calculated value of the first subset comprises at least one modified parameter;
determining a second subset of the plurality of calculated values, wherein each calculated value of the second subset depends from a calculated value in the first subset;
calculating updated values for the first subset based on the at least one modified parameter; and
calculating updated values for the second subset based on the updated values for the first subset.

9. The non-transitory computer readable medium of claim 8, wherein the determining the second subset comprises:
identifying calculated values other than the calculated values of the first subset, wherein a portion of the identified calculated values are based on at least one calculated value of the first subset.

10. The non-transitory computer readable medium of claim 9, wherein the at least one modified parameter is selected from a group consisting of a position of an individual within a business organization, rules to calculate calculated values, employees hierarchical relationships within the business organization, and a transactional data related to sales of products and/or services.

11. The non-transitory computer readable medium of claim 8, wherein calculating updated values for the first subset comprises:
identifying a first and a second portion for each calculated value of the first subset, wherein the first portion is associated with the at least one modified parameter, and wherein the second portion is a portion other than the first portion;
calculating the first portion based on the at least one modified parameter to form an updated first portion; and
calculating an updated calculated value for each calculated value based on the updated first portion and further based on the second portion.

12. The non-transitory computer readable medium of claim 8, wherein a calculated value from the second subset comprises a first portion and a second portion, wherein a first portion depends from the first subset and wherein the second portion is independent from the first subset, and wherein the first portion is recalculated based on the updated values from the first subset and wherein no recalculation is performed for the second portion to form updated value for the calculated value of the second subset.

13. The non-transitory computer readable medium of claim 8, wherein determining the first subset of the plurality of calculated values comprises:
comparing a timestamp associated with a first calculated value of the plurality of calculated values to a timestamp associated with a parameter of the first calculated value; and
determining that the parameter of the first calculated value is modified and determining that the first calculated value is part of the first subset of the plurality of calculated value if the timestamp associated with the parameter postdates the timestamp associated with the first calculated value.

14. The non-transitory computer readable medium of claim 8, wherein determining the second subset of the plurality of calculated values is based on a dependency attribute associated with a calculated value in the first subset.

15. A method comprising:
determining whether to recalculate a calculated commission payment value of one position from a plurality of calculated commission payment values associated with a plurality of positions within a business organization, wherein the determination is based on whether a parameter used to calculate the commission payment value is modified, wherein the plurality of calculated commission payment values is stored in a memory component;
determining whether a calculated commission payment value of another position of the plurality of positions depends from the calculated commission payment value of the one position; and
forming a subset of commission payment values associated with the one position and the another position to be recalculated.

16. The method of claim 15 further comprising:
recalculating a commission payment for the one position based on the modified parameter; and
recalculating a commission payment for the another position based on the recalculated commission payment of the one position.

17. The method of claim 15, wherein determining whether the another position depends from the one position is based on a dependency relationship between the one position and the another position.

18. The method of claim 15, wherein determining whether a parameter is modified comprises:
comparing a timestamp associated with the calculated commission payment value of the one position to a timestamp associated with the parameter; and
determining that the parameter is modified if the timestamp associated with the parameter postdates the timestamp associated with the calculated commission payment value of the one position.

19. The method of claim 15 further comprising:
prior to determining whether to recalculate, determining whether the plurality of calculated commission payment values exist; and
in response to determining that the plurality of calculated commission payment values do not exist, accessing an initial set of parameters stored in a memory component, wherein the initial set of parameters is associated with the business organization, and wherein the initial set of parameters is used to calculate the plurality of commission payment values associated with the plurality of positions.

20. The method of claim 15, wherein the modified parameter is selected from a group consisting of a position of an individual within the business organization, rules to calculate commission payment values, employees hierarchical relationships within the business organization, and a transactional data related to sales of products and/or services.
